(19) United States
(12) Patent Application Publication
(10) Pub. No.: US 2025/0284921 A1
(43) Pub. Date: Sep. 11, 2025

(54) MEDIATED ARTIFICIAL SUPER INTELLIGENCE SYSTEM THAT USES INTERNAL SUBJECTIVE EMOTIONS TO DRIVE SELECTION, GOAL SETTING, AND OTHER DECISION-MAKING AS A COLLECTIVE HUMAN AND ARTIFICIAL INTELLIGENCE BASED MIND WITH INTERNAL SUBJECTIVE EXPERIENCE

(71) Applicant: David James Kelley, Kent, WA (US)

(72) Inventor: David James Kelley, Kent, WA (US)

(21) Appl. No.: 17/891,163

(22) Filed: Mar. 5, 2024

(51) Int. Cl. G06N 3/004; G06N 3/045

(52) U.S. Cl. CPC G06N 3/004; G06N 3/045

(57) ABSTRACT

A mediated artificial superintelligence (mASI) system that uses internal subjective emotions to drive selection, goal setting, and other decision-making as a collective human and artificial intelligence (AI) based mind with internal subjective experience via complex thought models dynamically created by including collective training with an independent core observer model (ICOM) engineering artificial general intelligence (AGI) cognitive architecture is disclosed. The mASI system is a form of an AI system that also uses humans in the form of a collective mind with internal subjective experience. The mASI system extends the ICOM engineering AGI cognitive architecture by adding collective training to allow the system to dynamically created thought models more complex than otherwise possible with current technology while being able to use numerous AI technologies.

### CLAIM OF BENEFIT TO PRIOR APPLICATION

This application claims benefit to U.S. Provisional Patent Application 63/234,891, entitled “A MEDIATED ARTIFICIAL SUPER INTELLIGENCE SYSTEM THAT USES INTERNAL SUBJECTIVE EMOTIONS TO DRIVE SELECTION, GOAL SETTING, AND OTHER DECISION-MAKING AS A COLLECTIVE HUMAN AND ARTIFICIAL INTELLIGENCE BASED MIND WITH INTERNAL SUBJECTIVE EXPERIENCE,” filed Aug. 19, 2021. The U.S. Provisional Patent Application 63/234,891 is incorporated herein by reference.

### CROSS REFERENCE TO RELATED APPLICATIONS

This application is related to U.S. Provisional Patent Application 63/235,591, entitled “GRAPH RESPONSE MODEL GENERATION PROCESS,” filed Aug. 20, 2021. This application is also related to U.S. Provisional Patent Application 63/235,604, entitled “AN N-SCALE DATABASE SYSTEM THAT IS CONFIGURED TO SCALE OUT AND UP DYNAMICALLY WHILE MAINTAINING HIGH PERFORMANCE IN THEORETICALLY INFINITE AMOUNTS OF DATA,” filed Aug. 20, 2021.

### BACKGROUND

Embodiments of the invention described in this specification relate generally to artificial intelligence systems, and more particularly, to a mediated artificial superintelligence (mASI) system that uses internal subjective emotions to drive selection, goal setting, and other decision-making as a collective human and artificial intelligence (AI) based mind with internal subjective experience via complex thought models dynamically created by extending an independent core observer model (ICOM) engineering artificial general intelligence (AGI) cognitive architecture to include collective training.

Current conventional AI systems have problems being able to create smarter than human systems to attack problems that are too complex for humans and computers as currently used. The conventional AI systems that currently exist are based on complex logic coding but take no or very little account of emotions or subjective experience (which we humans take for granted and unconsciously help us to inform or guide our decision-making). Emotions are not to be confused with reward/punishment functions in narrow AI, such as are seen in reinforcement learning, as reward/punishment is just a kind of loss function. Rather, emotional models are demonstrated in the works of Plutchik (Plutchik 1980) and Willcox (Willcox 1982), with 8 (+8) and 72 emotional valences respectively.

Even more advanced AI systems that are designed to provide artificial general intelligence (AGI) have difficulties in approaching problems that human minds are incapable of solving. But they fail to employ internal subjective emotions to drive selection, goal setting, and other decision-making in and by the system beyond mere logic.

Therefore, what is needed is a way to use internal subjective emotions to drive selection, goal setting, and other decision-making in and by a system that does not rely exclusively on logic processing.

### BRIEF DESCRIPTION

A novel mediated artificial superintelligence (referred to as “mASI”) system and mASI process are disclosed. In some embodiments, the mASI system dynamically creates internal subjective experience via complex thought models and uses internal subjective emotions to drive selection, goal setting, and other decision-making as a collective human and artificial intelligence (AI) based mind with internal subjective experience via complex thought models dynamically created by extending an independent core observer model (referred to as “ICOM”) engineering an artificial general intelligence (referred to as “AGI”) cognitive architecture to include collective training. In some embodiments, the mASI system performs the mASI process for creating an intelligent, emotional-model-based system that is smarter than human systems to attack problems that are too complex for humans and computers as currently used. In some embodiments, the mASI system uses internal subjective emotions to drive selection, goal setting, and other decision-making in and by the mASI system, going far beyond computational logic processing. In some embodiments, the mASI system extends the ICOM engineering AGI cognitive architecture by adding collective training (human and machine) to allow the mASI system to dynamically create thought models that are more complex than possible with existing AI systems.

The preceding Summary is intended to serve as a brief introduction to some embodiments of the invention. It is not meant to be an introduction or overview of all inventive subject matter disclosed in this specification. The Detailed Description that follows and the

Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a mediated artificial superintelligence (mASI) process in some embodiments.

FIG. 2 conceptually illustrates an architecture of a mediated artificial superintelligence (mASI) system in some embodiments that uses internal subjective emotions to drive selection, goal setting, and other decision-making as a collective human and AI-based mind with internal subjective experience via complex thought models dynamically created by including collective training with the ICOM engineering AGI cognitive architecture.

FIG. 3 is a continuation of the mASI system of FIG. 2.

FIG. 4 is a continuation of the mASI system of FIG. 2.

FIG. 5 is a continuation of the mASI system of FIG. 2.

FIG. 6 is a continuation of the mASI system of FIG. 2.

FIG. 7 is a continuation of the mASI system of FIG. 2.

FIG. 8 illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments provide a mediated artificial superintelligence (mASI) system that uses internal subjective emotions to drive selection, goal setting, and other decision-making as a collective human and AI-based mind with internal subjective experience via complex thought models dynamically created by extending an ICOM engineering AGI cognitive architecture to include collective training. In some embodiments, the mASI system performs a mASI process for creating an intelligent, emotional-model-based system that is smarter than human systems to attack problems that are too complex for humans and computers as currently used.

In some embodiments, the mASI system comprises a mASI control system, an ICOM system, a deep neural network (DNN) and a DNN external network application programming interface (API) engine. In some embodiments, the mASI system works in connection with a plurality of external mediator agents. In some embodiments, the mASI control system comprises a mASI client framework, a mASI working graph meta model database, a mASI ICOM controller, a mediation queue, an a mediation observer queue. In some embodiments, the ICOM system comprises an ICOM context engine, an ICOM observer controller, an ICOM core, an ICOM context pump, an ICOM observer monitor, an ICOM memory pump, an ICOM data decomposition engine, an ICOM N-Scale graph database, an ICOM graph remover, an ICOM correlation engine, a context queue, and an ICOM threshold checker.

In some embodiments, the mASI system uses the internal subjective experience of the ICOM system to drive emotions and thereby drive selection, goal setting, and other decision-making as a collective human and AI-based mind. In some embodiments, the internal subjective experience of the ICOM system is based on objectively measurable data. In some embodiments, the internal subjective experience of the ICOM system is based on an emotional model. In some embodiments, the emotional model comprises a Plutchik emotional model. In some embodiments, the internal subjective experience of the ICOM system is based on sensory input associated with an emotional model. In some embodiments, the sensory input comprises hardware monitoring data. In some embodiments, human users add emotional values, contextual input, and associated data to enhance the complexity of emotional structures of the mASI system through collective intelligence. In some embodiments, input from an external mediator agent that conveys either emotional or contextual data may be used as a form of mediation. In some embodiments, the meta model database is configured to store emotional state data, goals data, and interests data that dynamically guide responses and actions. In some embodiments, the ICOM context engine is configured to call upon different instances and types of external neural networks according to input type data, goals data, and interests data. In some embodiments, the ICOM N-Scale graph database is initialized using seed material. In some embodiments, the seed material comprises a philosophical cornerstone to guide ethical behavior according to the selected philosophy. In some embodiments, the seed material comprises a body of text representing fundamental world knowledge.

As noted above, current conventional AI systems are limited in their pursuit to attack and solve problems that are too complex for humans and computers as currently used. The conventional AI systems that currently exist are based on complex logic coding, but take no or very little account of emotions or subjective experience. Even more advanced AI systems that are designed to provide AGI have difficulties in approaching problems that human minds are incapable of solving. In short, beyond mere logic, they fail to employ internal subjective emotions to drive selection, goal setting, and other decision-making in and by the system. Embodiments of the mASI system described in this specification solve such problems by combining numerous AI-related technologies with humans as a driving force behind superintelligence thinking by creating better training data in real-time, identifying bias in human thought, and by structuring complex problems in new ways, and generating solutions.

Embodiments of the mASI system described in this specification differ from and improve upon currently existing options. In particular, there is no other system that is internally self-aware and thinks and performs provably at superintelligence levels. While most conventional AI systems try to solve a problem using logic-based processing in an attempt to solve things like a human mind, these conventional AI systems fail to provide a human-like structured subjective emotional experience. In this way, the conventional systems and processes are approaching the problem wrong. By contrast, the mASI system of the present disclosure allows for the dynamic creation of thought models that are more complex than otherwise possible with current technology while being able to use numerous AI technologies together in new and novel ways.

The mASI system that uses internal subjective emotions to drive selection, goal setting, and other decision-making as a collective human and AI-based mind with internal subjective experience via complex thought models dynamically created by including collective training with the ICOM engineering AGI cognitive architecture of the present disclosure may be comprised of the following elements. This list of possible constituent elements is intended to be exemplary only and it is not intended that this list be used to limit the mASI system of the present application to just these elements. Persons having ordinary skills in the art relevant to the present disclosure may understand there to be equivalent elements that may be substituted within the present disclosure without changing the essential function or operation of the mASI system.

1. mASI Client Framework

2. mASI working Graph Meta Model Database (DB)

3. mASI ICOM Controller

4. Mediation Queue

5. Mediation Observer Queue

6. ICOM Context Engine

7. ICOM Observer Controller

8. ICOM Core

9. ICOM Context Pump

10. ICOM Observer Monitor

11. ICOM Memory Pump

12. ICOM Data Decomposition Engine

13. ICOM N-Scale Graph Database

14. ICOM Graph Remover

15. Deep Neural Network (DNN) External Network API Engine

16. ICOM Correlation Engine

17. Context Queue

18. ICOM Threshold Checker

19. Mediator Agents

The various elements of the mASI system of the present disclosure may be related in the following exemplary fashion. It is not intended to limit the scope or nature of the relationships between the various elements and the following examples are presented as illustrative examples only. Each component is an independent system or human as part of the overall collective consciousness system or hive mind. Functionally all components can be placed in four categories, namely, (i) external mediator agents (#19), (ii) the mASI control system (including the mASI client framework (#1), the mASI working graph meta model DB (#2), the mASI ICOM controller (#3), the mediation queue (#4), and the mediation observer queue (#5)), (iii) the DNN external network API engine (#15), and (iv) the ICOM parts of the system which is everything else. Essentially, the mASI client framework (#1) plus information from the mASI working graph meta model DB (#2), the mASI ICOM controller (#3), and the mediation queue (#4) provide items that need input from the ICOM observer monitor (#10) or from external systems. The mASI ICOM controller (#3), plus all of this response data, builds a knowledge graph that is passed into the ICOM context engine (#6) that uses the ICOM correlation engine (#16) and the DNN external network API engine (#15) to build models. External systems can pass the model to the ICOM context engine (#6) and the ICOM data decomposition engine (#12) for processing and all of this is passed back to the mASI ICOM controller (#3) to be placed into the mediation queue (#4) for further input from the ICOM observer monitor (#10) and additional processing. Eventually, once enough reviews or a threshold is met or occurs, those items passed into the ICOM context engine (#6) and the ICOM data decomposition engine (#12) are processed through the ICOM correlation engine (#16) and into the context queue (#17) which is curated by the ICOM graph remover (#14) to prevent memory problems. Knowledge graphs are passed out of the context queue (#17) and into the ICOM N-scale graph database (#13) and the ICOM core (#8) which experiences (processes) the knowledge graph for decisions and choices and passed to the ICOM core (#8), the ICOM observer monitor (#10), and the ICOM memory pump (#11), all of which runs through the ICOM observer controller (#7) and passed back to the ICOM context engine (#6) or the ICOM context pump (#9) through the ICOM observer monitor (#10) and directly to the ICOM N-scale graph database (#13) and the context queue (#17) based on various parameters. The ICOM observer controller (#7) communicates actions from those knowledge graphs externally to the system and places things in the mediation observer queue (#5) for analysis and reprocessing. In some embodiments, “thoughts” are the knowledge graphs with emotional models that are part of the graphs that are used for all decisions, choices, interests, goals, and actions of the system. These are not processed by standard computer logic but through mathematical models based on a matrix that translates emotional states to numbers through the matrix and back again. The ICOM core (#8) also maintains the current emotional states of the machine both high and low levels.

The mASI system of the present disclosure generally works by the processing of each step or component, which are in turn encapsulated with internal sub-processing and components. However, the removal of any one of the components may render a different result. Components work together by passing knowledge graphs, which are a type of data tree, back and forth to each other as per the flow noted earlier. There are some components that can work one at a time but functionality is extremely limited. For example, the DNN external network API engine (#15) involves a DNN-based API engine that will respond to any authenticated calls yet it will not be able to do anything else on its own. When working together in this way, the mASI system is able to make premeditated actions.

In a currently preferred embodiment, the mASI system is implemented in software with millions of lines of code. Although future programming paradigms and/or enhanced computing processing power may result in reduced encoding for the software, it is important to understand that the most important decision-making process is using the differences between different sets of mathematical matrices that represent emotional states associated with the actions of thought models (knowledge graphs) and models representing internal subjective emotional states objectively and various goals, interests, and focuses identified previously by the core. It is in this processing that the mASI system experiences its choices and produces a double abstraction getting away from traditional binary-oriented computer logic.

To make the mASI system of the present disclosure, a person would start by setting up the system for deployment. Setting up the system involves numerous computer and network subsystems traditionally set up as cloud application architectures. In some embodiments, each component of the mASI system needs to run on a computer or computer container except the mediator agents (#19).

Correct setup of the mASI system involves the proper implementation of the ICOM Theory of Consciousness which is partially built on the Computational Theory of Mind (Rescorla 2016), where one of the core issues with research into AGI is the absence of objective measurements and data as they are ambiguous given the lack of agreed-upon objective measures of consciousness (Seth 2007). To continue serious work in the field, there needs to be a way to measure consciousness in a consistent way that is not presupposing different theories of the nature of consciousness (Dienes and Seth 2012) and further not dependent on various ways of measuring biological systems (Dienes and Seth 2010) but focused on the elements of a conscious mind in the abstract. With the more nebulous Computational Theory of Mind, research into the human brain does show some underlying evidence which the Independent Core Observer Model Theory of Consciousness (ICOMTC) builds on. The ICOMTC is described further below.

Specifically, the Independent Core Observer Model Theory of Consciousness (ICOMTC) addresses key issues with being able to measure physical and objective details, as well as the subjective experience of the system (known as qualia), including mapping complex emotional structures, as seen in previously published research related to the ICOM cognitive architecture (Kelley 2016). By having this ability to measure, it is possible to test additional theories and make changes to the system as it currently operates. Slowly and increasingly what is revealed is a system that can make decisions that are illogical and emotionally charged, yet objectively measurable (Chalmers 1995), and it is in this space where there is the hope of success that true artificial general intelligence will work “logically” as one might expect from a human mind. ICOMTC allows one to objectively model subjective experience in an operating software system that is or can be made self-aware.

In some embodiments, a large number of mediator agents enhances the performance of the mASI system. Specifically, without a pool of mediators (#19) actively interacting with the system as a whole, it is unlikely able to achieve performance greater than a human. Several other theoretical approaches to some of the components could improve the system including the sparse update model that would create graph model systems based on idealized mediators and contextual data that if large and complete enough would allow the system to work independently as a full-blown AGI. Furthermore, integration systems that take input from various sensors and translate that data into graph models (knowledge graphs) the system could be made to see, hear, and otherwise interact with the world outside of the computer using could also facilitate AGI operation. An augmented reality (AR) client or a direct neural interface (DNI) would allow the mASI system to respond in almost real-time even as a collective. A wide variety and many combinations of modular components that capture emotional and contextual data could be applied to serve this function for the system. In some embodiments, this mediation data could be captured in real-time much the same way that humans capture it from one another by reading emotional reactions in vocal patterns, facial muscles, and posture.

To use the mASI system of the present disclosure, a user would submit a question and ask for help, much like a person would do in relation to another person, but through one of the operating input modes. This could be used to solve technology research questions such as solving climate change or getting policy recommendations or could be used in e-governance scenarios. The mASI system could be used as the core of a corporation where employees are the ‘mediators’ and the system makes the final decision for and on behalf of the corporation. The mASI systems would turn the groups that properly used them into a sort of superintelligent metaorganisms. Mediated Artificial Superintelligence collective systems could solve virtually any problem that humans can but better, as well as potentially solving some they cannot. For example, filtering out more than 188 cognitive biases that the human brain frequently expresses. There is no current method for consistently performing at the intellectual levels of the mASI system. The mASI system could be used in different ways provided the internal structure of the system remains the same and the ICOMTC is functioning along with all the needed resources and a pool of mediators, or other systems performing the same function.

Additionally, the mASI system could be adapted for use in any field to create a superintelligent expert in that field using existing experts and amplifying their knowledge and abilities. The mASI system could also be adapted in ways to author books, write laws, advise on or make policy decisions, or be used as an e-governance system for selecting candidates for public office. By integration with other systems, the mASI system could also be used to design new products and services on its own. While the mASI system cannot independently produce physical products without adding things like 3D printers and robotics, it is conceived that by providing access to those additional machines, devices, processes, etc., the mASI system could be adapted for use in producing anything those machines would be capable of outputting.

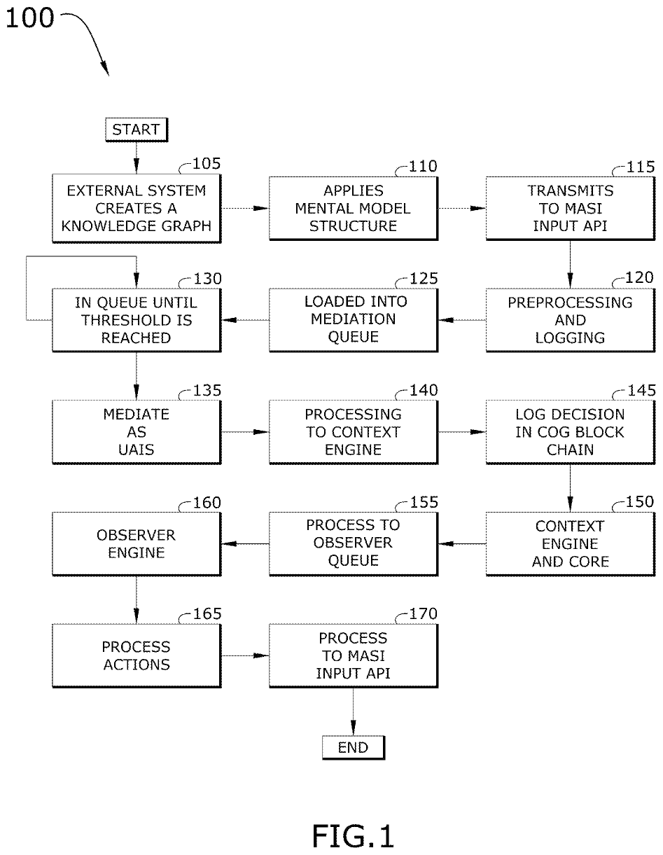

By way of example, FIG. 1 conceptually illustrates a mediated artificial superintelligence (mASI) process 100. In some embodiments, the mASI process 100 starts by way of some automatic or event-based input or some other automatic or event-based triggering condition (hereinafter referred to as “the starting input” for purposes of the description of this figure). When started, the mASI process 100 proceeds to a step for creating a knowledge graph by an external system (at 105). Specifically, the external system creates the knowledge graph by processing the starting input into a format of a knowledge graph. The format is intended to align with subsequent processing steps of the mASI process 100. After the knowledge graph is created, the mASI process 100 further aligns the formatting with the mASI-based system by applying a mental model structure to the incoming knowledge graph (at 110) created by the external system. Applying the mental model structure to the incoming knowledge graph can serve to contextualize and otherwise enrich the knowledge graph.

In some embodiments, the mASI process 100 transmits (at 115) the resulting knowledge graph to the mASI input API where narrow AI tools, such as language models and grammar checkers, may be called upon through one or another method. An example of a method used to call upon such narrow AI tools is the method described by reference to the U.S. Provisional Patent Application 63/235,591 filed Aug. 20, 2021 and entitled “GRAPH RESPONSE MODEL GENERATION PROCESS”.

In some embodiments, the mASI process 100 then performs preprocessing and logging of the results (at 120). This is followed by loading the results into the mediation queue (at 125), where humans have the opportunity to engage in a mediation process that involves adding various forms of input, such as emotions, priorities, and metadata tags that point to associated concepts. In some embodiments, the mASI process 100 maintains the results in the mediation queue until a threshold is reached (at 130). Specifically, the mediation process is repeated for a number of unique mediators. In some embodiments, the number of unique mediators is configured (in system settings) as a required number of unique mediators. Next, the mASI process 100 proceeds to mediate as UAIS (at 135) during which the results of the repeated mediation process (for the number of unique mediators) is combined with the system's own assessment.

After the mediation processing steps are completed, the mASI process 100 of some embodiments processes system information which flows back into the context engine (at 140) followed by logging decisions on the COG blockchain (at 145). Additionally, the mASI process 100 includes steps whereby information flows through the context engine and into the ICOM core (at 150), where the arguably conscious portion of the system's processing takes place and the system decides what goals to set, what actions to take, and what further research may be needed to reach a decision. At the next step of the mASI process 100, the information is processed and sent to the observer queue (at 155) where the observer engine (at 160) processes actions (at 165). Specifically, when the information is processed and sent to the observer queue and observer engine, the system performs any selected actions, such as sending an email or posting to a website. The mASI process 100 proceeds to a processing step which involves the mASI input API (at 170) integrating knowledge of the actions performed into the system's sum of knowledge, the graph database. After integrating the knowledge of the actions performed for the present iteration, the mASI process 100 ends.

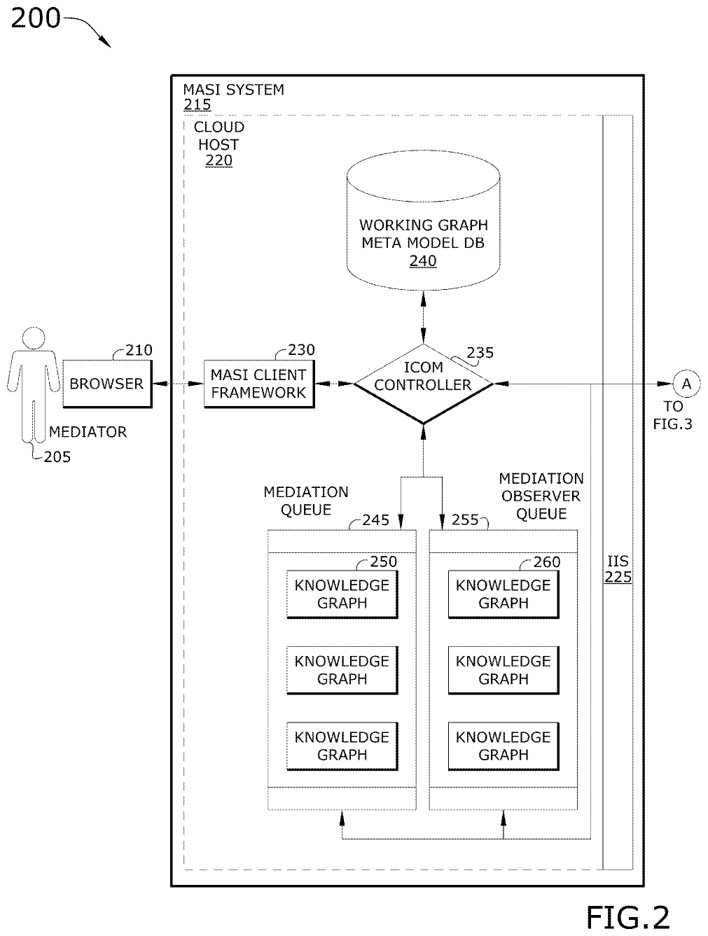

By way of example, FIGS. 2-7 conceptually illustrate an architecture of a mediated artificial superintelligence (mASI) system (also referred in its entirety as the “mediation system”) that uses internal subjective emotions to drive selection, goal setting, and other decision-making as a collective human and AI-based mind with internal subjective experience via complex thought models dynamically created by including collective training with the ICOM engineering AGI cognitive architecture 200. Several components, functions, connections, and process steps of the mediation system are shown throughout FIGS. 2-7 to demonstrate a number of possible ways that information may flow through the system as a whole. This list of possible constituent components, functions, connections, and process steps is intended to be exemplary only and it is not intended that this list be used to limit the mASI system of the present disclosure to just these components, functions, connections, and process steps. Persons having ordinary skills in the art relevant to the present disclosure may understand there to be equivalent components, functions, connections, and process steps that may be substituted within the present disclosure without changing the essential function or operation of the mASI system.

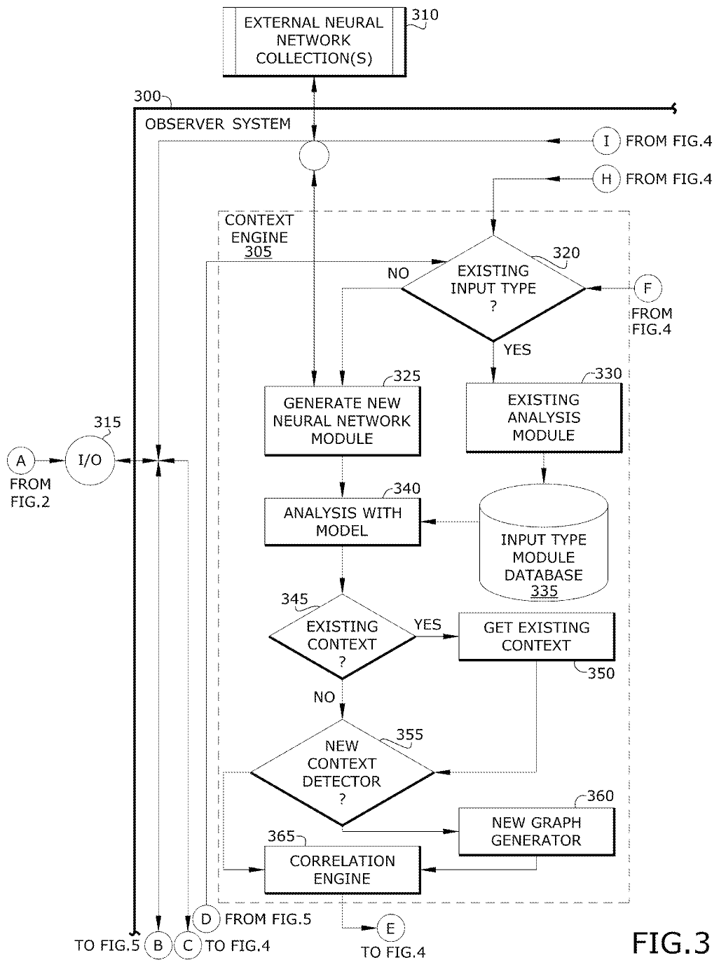

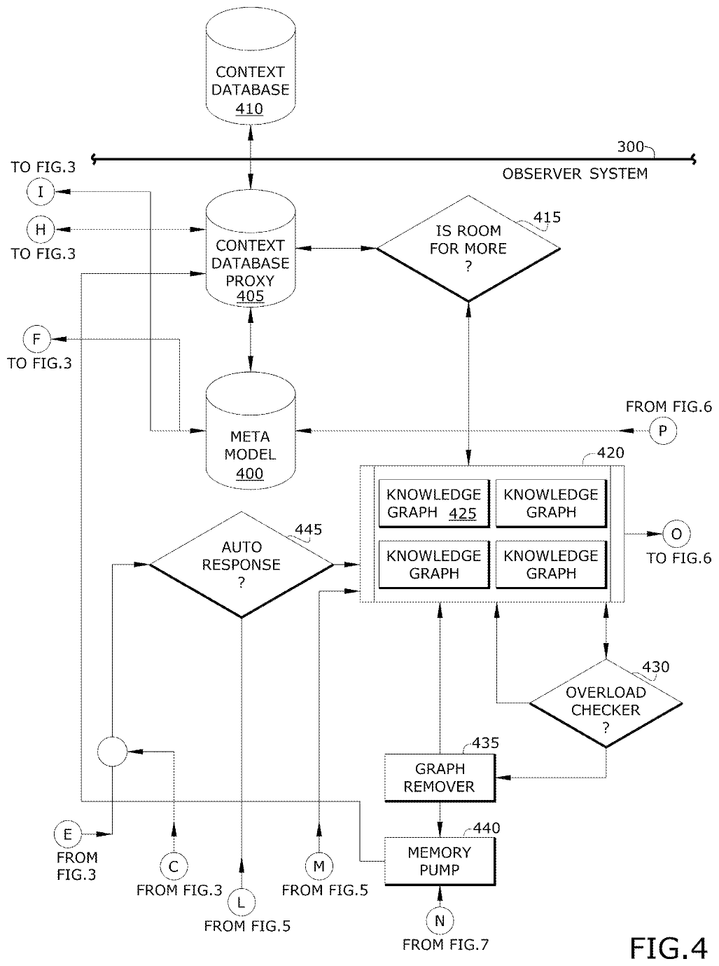

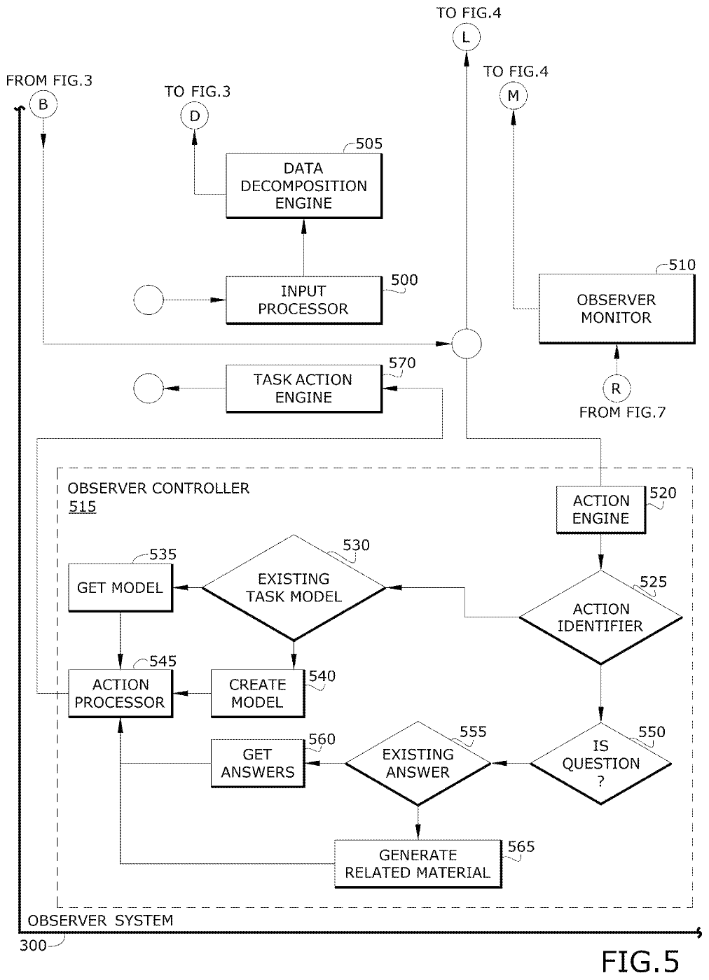

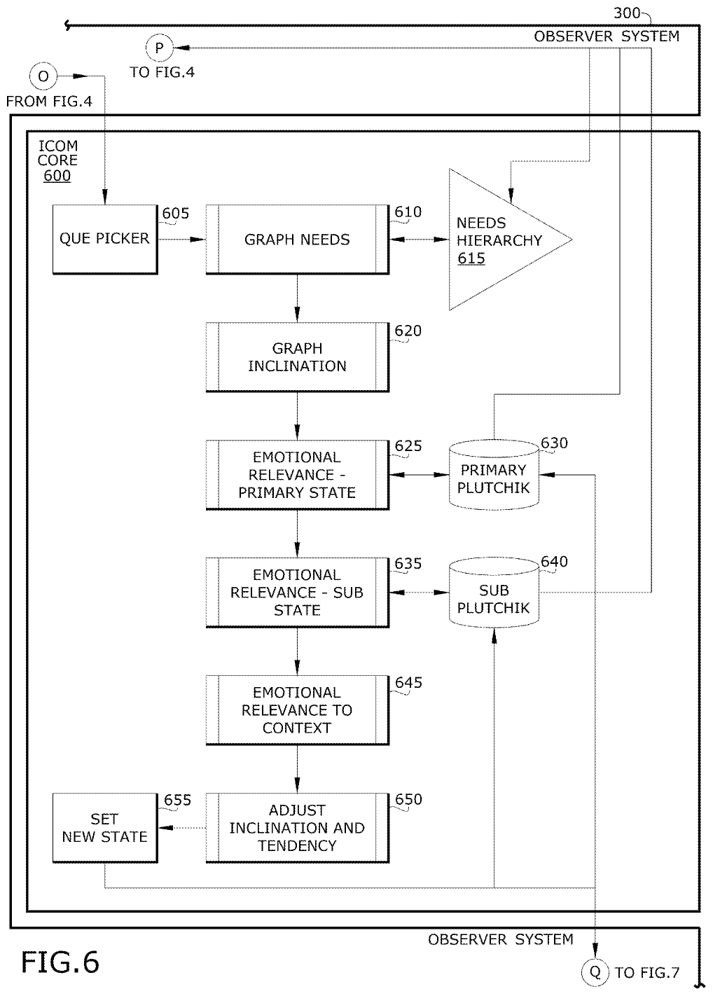

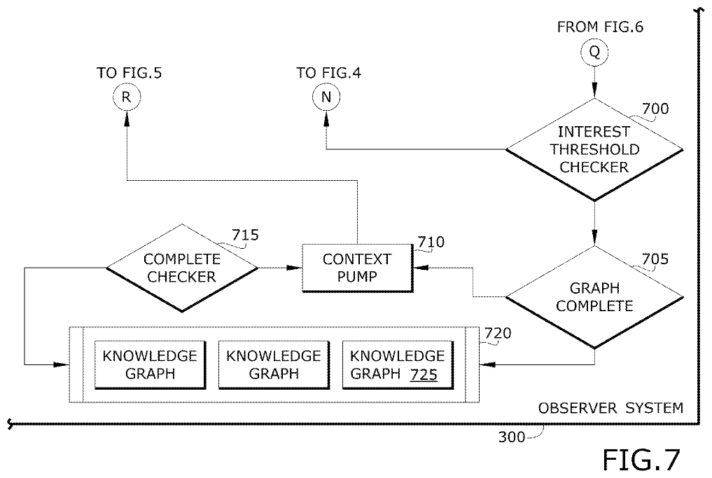

Specifically, the components, functions, connections, and process steps shown in these figures are labeled with reference characters corresponding to the figure in which they appear. Specifically, FIG. 2 shows a human mediator 205, a browser 210, a mediated artificial superintelligence (mASI) system 215, a cloud platform 220 with Internet Information Services (IIS) 225, a mASI client framework 230, an independent core observer model (ICOM) controller 235, a working graph meta model database 240, a mediation queue 245 with a plurality of knowledge graphs 250, and an observer queue 255 with a plurality of knowledge graphs 260. In FIG. 3, an observer system 300 is shown. The observer system 300 includes a context engine 305 with a new graph generator 360 and a correlation engine 365. The context engine is configured to perform a process for determining (at 320) whether data corresponds to an existing input type and other steps that result in information flowing to the new graph generator 360 and the correlation engine 365 before being passed on to an auto response function, which is demonstrated in FIG. 4. A collection of external neural networks 310 are communicably connected to the observer system 300. Furthermore, input/output (I/O) communication 315 is established between the observer system 300 and the ICOM controller 235. More components of the observer system 300 are shown in FIG. 4, namely, a meta model 400, a context database proxy 405, a context database 410, an available room checker 415 that is configured to determine whether there is room to load more knowledge graphs, an active collection of knowledge graphs 420 with a plurality of active knowledge graphs 425, an overload checker 430, a graph remover 435, a memory pump 440, and an auto response checker 445. FIG. 5 includes additional components and functions of the observer system 300 including an input processor 500, a data decomposition engine 505, an observer monitor 510, an observer controller 515, and a task action engine 570. The observer controller 515 includes an action engine 520 and an action processor 545 and is configured to perform a process to retrieve or create a model and/or retrieve answer or generate materials. FIG. 6 focuses on the ICOM core 600 which interacts with the observer system 300. The ICOM core 600 includes a queue picker 605, a hierarchy of needs 615, a primary emotional model 630, a subconscious emotional model 640, and a knowledge graph needs process 610, a knowledge graph inclination process 620, a primary state emotional relevance process 625, a subconscious state emotional relevance process 635, a contextual emotional relevance process 645, a logical inclination and tendency adjustment process 650, and a new state setting process 655. FIG. 7 provides additional components and functions of the observer system 300 in connection with the ICOM core 600. Specifically, the additional components and functions of the observer system 300 shown in this figure include an interest threshold checker 700, a graph completion checker 705 configured to determine if a graph is complete, a context pump 710, a completeness checker 715, and a collection of graphs 720 that includes a plurality of knowledge graphs 725.

The mediation system works primarily through the operation of the main components including the mASI system 215, the observer system 300, and the ICOM core 600. As shown in FIG. 2, the human mediator 205 accesses the mASI system 215 via the browser 210. The mASI system 215 is hosted by the IIS 225 cloud platform 220, such that the browser 210 allows the human mediator 205 to log into the mASI client framework 230. Once logged in, the ICOM controller 235 determines and handles the presentation, organization, and distribution of information as it flows through the mediation system. In this process, the ICOM controller 235 calls upon data from the working graph meta model database 240 to contextualize and populate the mediation queue 245 and the observer queue 255, which in turn allow for human input and auditing processes. Each of these queues has knowledge graphs 250 and 260 associated with the information flowing through them, which are then passed back to the ICOM controller 235.

The application process 200 then follows an outflow process indicated by marker point “A”, which leads to a continuation of the application process in FIG. 3. . . . Specifically and by way of reference, FIG. 3 shows application process 300 starting at marker point “A” which follows marker point “A” outflow in FIG. 2.

The ICOM controller 235 may then communicate with the observer system 300, shown in FIG. 3. This is shown by outflow marker point “A” in FIG. 2 which directs the flow to FIG. 3. Thus, starting at inflow marker point “A” in FIG. 3, I/O communication 315 is established between the ICOM controller 235 and the observer system 300. In particular, the ICOM controller 235 may communicate with a few different subsystems in the observer system 300 including, without limitation, the observer controller 515, shown in FIG. 5, and the auto response checker 445, shown in FIG. 4.

For communication with the observer controller 515, an outflow marker point “B” directs the I/O communication 315 from the ICOM controller 235 to FIG. 5, in which inflow marker point “B” flows to the observer controller 515. Data flowing to the observer controller 515 first reaches the action engine 520 for formatting, before being classified by an action identifier 525 for further processing. Through this processing, the observer controller 515 of the observer system 300 determines if the action relates to a question (at 550) or a task model (at 530). When the classified action is determined (at 550) to relate to a question, the observer controller 515 then considers any existing answers and determines (at 555) whether any of the existing answers are applicable and also determining (at 555) whether to locate more answers (at 560) or generate related material (at 565) to help better answer the question. Any and all such information (whether existing answers are retrieved or related materials generated) is then provided to the action processor 545, which thereafter provides the information to the task action engine 570, which performs the tasks. On the other hand, when the classified action is determined (at 530) to relate to a task model, the observer controller 515 then determines (at 530) whether to retrieve an existing model (at 535) or create an improved model (at 540), before being passed on to the action processor 545. As noted above, information then flows from the action processor 545 to the task action engine 570, which handles performing the tasks.

There are several different routes information may flow through as the ICOM controller 235 in communication 315 with the auto response checker 445. Also, the information flow may or may not incorporate data flowing through the context engine 305. At least one route of I/O communication 315 between the ICOM controller 235 and the auto response checker 445 is denoted by the outflow marker point “C” which flows into FIG. 4 at the corresponding inflow marker point “C” for evaluation by the auto response checker 445. Another route of I/O communication 315 between the ICOM controller 235 and the auto response checker 445 is out through the correlation engine 365 of the context engine 305 and denoted by the outflow marker point “E” which flows into FIG. 4 at the corresponding inflow marker point “E” for evaluation by the auto response checker 445. In both cases, the auto response checker 445 interacts with the active collection 420 of individual knowledge graphs 425 currently loaded into memory. From this collection 420 of knowledge graphs 425, the overload checker 430 and the graph remover 435 serve to regulate the memory pump 440 and prevent an overflow of memory. The active collection 420 of individual knowledge graphs 425 also interacts with the available room checker 415 to determine whether there is room to load more knowledge graphs into memory. The available room checker 415, in turn, interacts with the context database proxy 405. The context database proxy 405 is configured to handle interactions with the context database 410, the meta model 400, input from the memory pump 440, and interactions with the context engine 305 (denoted by the flow marker point “H” which flows into FIG. 3 at the corresponding flow marker point “H” for interaction with the context engine 305). The meta model 400 is configured to interact with the ICOM controller 235 (denoted by the flow marker point “I” which flows into FIG. 3 at the corresponding flow marker point “I” for I/O communication 315 back to the ICOM controller 235 over flow marker “A” into FIG. 2) and with the context engine 305 (denoted by the flow marker point “F” which flows into FIG. 3 at the corresponding flow marker point “F” for interaction with the context engine 305), while receiving emotional valence data from the ICOM core 600 (denoted by the inflow marker point “P” which flows into the meta model 400 from the corresponding outflow marker point “P” from the ICOM core 600 in FIG. 6 and by way of the observer system 300). The emotional valence data received by the meta model 400 from the ICOM core 600 is used for interaction with the context engine 305 in the form of primary Plutchik model data 630, subconscious Plutchik model data 640, and emotional modifiers from the system's hierarchy of needs 615.

From the active collection 420 of individual knowledge graphs 425 loaded into memory, information flows to the ICOM core 600, denoted by the outflow marker point “O” which flows out of FIG. 4 and into FIG. 6 at the corresponding inflow marker point “O” for evaluation by the queue picker 605. Specifically, the queue picker 605 is configured to retrieve knowledge graphs via the knowledge graph needs process 610, which incorporates data from the current hierarchy of needs 615. The ICOM core 600 then performs the knowledge graph inclination process 620, which allows for an inclination towards the information to be established. This facilitates the primary state emotional relevance process 625 in assigning appropriate primary, or conscious, emotional valences towards the information before being applied to the primary emotional model 630. After primary emotional valences are assigned, the ICOM core 600 performs the subconscious state emotional relevance process 635 to assign subconscious emotional valences, which are updated in the subconscious emotional model 640. Next, the ICOM core 600 performs the contextual emotional relevance process 645 to consider the emotional relevance to the context. Considering the relevance of emotional responses to the context allows for logical adjustments to inclination and tendencies to be made by the ICOM core 600 performing the logical inclination and tendency adjustment process 650. Then the ICOM core 600 performs the new state setting process 655, which applies the logical adjustments to inclination and tendencies to a new state which, in turn, may trigger updating of the primary emotional model 630 and the subconscious emotional model 640, as well as adjusting the interest threshold checker 700 (denoted by the outflow marker point “Q” which flows into the observer system 300 and out of FIG. 6 and flows into FIG. 7 at the corresponding inflow marker point “Q” to the interest threshold checker 700).

As shown in FIG. 7, and denoted by the outflow marker point “N” which flows into FIG. 4 at the corresponding inflow marker point “N”, the interest threshold checker 700 may pass knowledge graphs to the memory pump 440. The memory pump 440, in turn, sends the knowledge graphs to the context database proxy 405 and, by its own interconnection, from the context database proxy 405 to the context database 410. Thus, the knowledge graphs from the interest threshold checker 700 are stored in the context database proxy 405 and the context database 410. The interest threshold checker 700 also passes the information on to the graph completion checker 705, which determines whether the graph is complete. Additionally, the graph completion checker 705 may consider and feed into connections with one or more individual knowledge graph from the plurality of knowledge graphs 725 in the collection of graphs 720. Furthermore, the graph completion checker 705 may also consider and feed into the context pump 710 and the completeness checker 715, vetting both flows of information. From the context pump 710, results flow into the observer monitor 510 (denoted by the outflow marker point “R” which flows out of FIG. 7 and into FIG. 5 at the corresponding inflow marker point “R”), and from the observer monitor 510 back into the active collection 420 of individual knowledge graphs 425 loaded into memory (denoted by the outflow marker point “M” which flows out of FIG. 5 and into FIG. 4 at the corresponding inflow marker point “M”).

The meta model 400 and context database proxy 405 interact with the context engine 305 (denoted by outflow marker points “F” and “H”, respectively, flowing out of FIG. 4 and into FIG. 3 at the corresponding inflow marker points “F” and “H”) by sending knowledge graphs and the system's emotional state data, goals, and interests. The context engine 305 itself first determines (at 320) whether the incoming data corresponds to an existing input type. This determination (at 320) calls upon the input processor 500 and the data decomposition engine 505, both shown in FIG. 5. The input type is then provided back to the context engine 305 (denoted by outflow marker point “D” from the data decomposition engine 505 in FIG. 5 to the corresponding inflow marker point “D” flowing into the context engine 305 in FIG. 3) Depending on the input type, the context engine can flow through different sets of process steps. Specifically, when the input type is determined (at 320) to be an existing data type, the context engine 305 selects an existing analysis module (at 330) from an input type module database (at 335), and performs an analysis (at 340) which produces some resulting analysis with model. Alternatively, when the input type is not determined (at 320) to be an existing data type, then the context engine 305 generates a new neural network module (at 325), calling upon the collection of external neural networks 310 in the process of creating the new neural network module. After generating the new neural network module, the context engine 305 performs the analysis (at 340), which produces some resulting analysis with model. The resulting analysis (with model) is then checked against existing context (at 345). When any context is found that relates to any existing context, the context engine 305 proceeds to call upon it by retrieving the existing context (at 350), followed by determining (at 355) whether there is any new context, via a system for the detection of new context. Turning back to the check against existing context (at 345), when nothing relates to existing context, the context engine 305 triggers the system for the detection of new context to determine (at 355) whether there is any new context. The outcome may then flow to the new graph generator 360 as well as the correlation engine 365, before being passed on to the auto response checker 445 (denoted by outflow marker point “E” from the correlation engine 365 in FIG. 3 to the auto response checker 445 in FIG. 4 via the corresponding inflow marker point “E”) and back into the active collection 420 of individual knowledge graphs 425 loaded into memory.

The iterative improvement of individual modules and the ways in which they connect in the above-described embodiments of the invention may enhance and expand the capacities of the system as a whole without deviating from the ICOMTC. The system's modular design allows for new narrow AI technologies and sensors to be repurposed as tools for the system as those technologies emerge, allowing for novel enhancements to each functional component of the system over time, as new forms of data and processing are added to the functions described.

For example, infrared sensors, typical cameras, and microphones could be utilized and combined to extract the same functional data gathered by other embodiments of the mediation system, in real-time, at whatever scale the information was presented to an audience where those systems were present, even if not all of those systems were present for all members of that audience. The human subconscious emotional responses and associations may be measured or closely approximated in many ways while still conforming to the ICOMTC. Systems of approximation may be based on specific individual humans with a volume of measured data or collections of two or more humans, while also potentially being augmented by other mASI and ICOM-based systems.

As much of the value contributed by humans, in the embodiments where they are present, isn't inherently conscious or logical then mASI systems don't require those humans to possess any expert knowledge of the subject matter, unlike historic AI systems including “expert systems” where rules were often hand-designed by experts in a field. Rather, a group of humans with diverse and ordinary skills may contribute the value of their subconscious reactions collectively to form less biased emotional responses supplemented by the logical capacities of ICOM-based systems. Since reducing bias raises the intelligence of resulting decisions this application of the “Wisdom of Crowds” concept over emotional reaction and association can serve as a robust source of motivation without the bias of any one individual's emotional responses dominating.

In another example, multiple ICOM cores could be integrated into a single mASI system, offering the benefits of collective intelligence not only through diverse feedback from humans but also from more than one cognitive architecture core, each with different philosophical seeds to yield distinct and diverse perspectives. This diversity of philosophical seed material may serve to enhance ethical quality as well as performance by helping an mASI system overcome the biases and blind spots inherent to any single philosophy. Likewise, these mASI systems may also be nested one inside another, each with one or more ICOM cores. All of these examples may be accomplished without diverging from the ICOMTC.

The above-described embodiments of the invention are presented for purposes of illustration and not of limitation. Also, many of the above-described features and applications are implemented as software processes that are specified as a set of instructions recorded on a computer readable storage medium (also referred to as computer readable medium, machine readable medium, or non-transitory computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

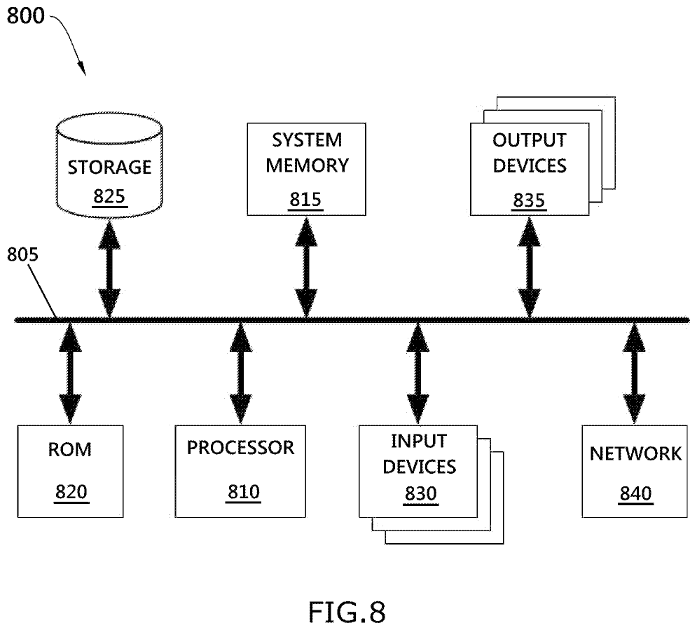

FIG. 8 conceptually illustrates an electronic system 800 with which some embodiments of the invention are implemented. The electronic system 800 may be a server, a desktop or laptop computer, a phone or mobile device, a personal digital assistant (PDA), or any other sort of electronic device. Such an electronic system includes various types of computer readable media and interfaces for various other types of computer readable media. Electronic system 800 includes a bus 805, processing unit(s) 810, a system memory 815, a read-only memory 820, a permanent storage device 825, input devices 830, output devices 835, and a network 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system 800. The permanent storage device 825, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a flash drive) as the permanent storage device 825. Like the permanent storage device 825, the system memory 815 is a read-and-write memory device. However, unlike storage device 825, the system memory 815 is a volatile read-and-write memory, such as a random access memory. The system memory 815 stores some of the instructions and data that the processor needs at runtime. In some embodiments, the invention's processes are stored in the system memory 815, the permanent storage device 825, and/or the read-only memory 820. For example, the various memory units may store knowledge graphs and other instructions for runtime processing by the mediated artificial superintelligence (mASI) system of some embodiments. From these various memory units, the processing unit(s) 810 retrieves instructions to execute and data to process in order to execute the processes of the mASI system in some embodiments.

The bus 805 also connects to the input and output devices 830 and 835. The input devices enable the user to communicate information and select commands to the electronic system. The input devices 830 include alphanumeric keyboards, pointing devices (also called “cursor control devices”), audio input devices (such as microphones), etc. The output devices 835 display images and information generated by the electronic system 800. The output devices 835 include display devices, such as liquid crystal displays (LCD) and organic light emitting diode (OLED) displays, as well as other conventional output devices, such as printers and audio speakers. Some embodiments include devices such as a touchscreen that functions as both input and output devices.

Finally, as shown in FIG. 8, bus 805 also couples electronic system 800 to a network 840 through a network adapter (not shown). In this manner, the computer can be a part of a network of computers (such as a local area network (“LAN”), a wide area network (“WAN”), or an intranet), or a network of networks (such as the Internet). Any or all components of electronic system 800 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, disc media (CDs, DVDs, Blu-Ray® discs, ultra density optical discs, any other optical or magnetic media), flash memory (e.g., SD cards, mini-SD cards, micro-SD cards, etc.), magnetic and/or solid state hard drives, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 1 and parts of FIGS. 2-7 conceptually illustrate processes. The specific operations of these processes may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A mediated artificial superintelligence (mASI) system that uses internal subjective emotions to drive selection, goal setting, and other decision-making as a collective human and artificial intelligence (AI) based mind with internal subjective experience via complex thought models dynamically created by including collective training with an independent core observer model (ICOM) engineering artificial general intelligence (AGI) cognitive architecture comprising:
a plurality of external mediator agents;
a mASI control system comprising a mASI client framework, a mASI working graph meta model database, a mASI ICOM controller, a mediation queue, and a mediation observer queue;
a deep neural network (DNN) external network application programming interface (API) engine; and
an independent core observer model (ICOM) system comprising an ICOM context engine, an ICOM observer controller, an ICOM core, an ICOM context pump, an ICOM observer monitor, an ICOM memory pump, an ICOM data decomposition engine, an ICOM N-Scale graph database, an ICOM graph remover, an ICOM correlation engine, a context queue, and an ICOM threshold checker.

2. The mASI system of claim 1, wherein the ICOM core has an internal subjective experience of objectively measurable data.

3. The mASI system of claim 2, wherein the internal subjective experience is based on an emotional model.

4. The mASI system of claim 3, wherein the emotional model comprises a Plutchik emotional model.

5. The mASI system of claim 2, wherein the internal subjective experience is based on sensory input associated with an emotional model, wherein the sensory input comprises hardware monitoring data.

6. The mASI system of claim 1, wherein humans add emotional values and associative data to the mediation system to enhance the mASI system's complexity through collective intelligence.

7. The mASI system of claim 1, wherein any form of input that conveys at least one of emotional data and contextual data is used as a form of mediation from an external agent.

8. The mASI system of claim 1, wherein the meta model database is configured to store emotional state data, goals data, and interests data that dynamically guide responses and actions.

9. The mASI system of claim 8, wherein the ICOM context engine is configured to call upon different instances and types of external neural networks according to input type data, the goals data, and the interests data.

10. The mASI system of claim 1, wherein the ICOM N-Scale graph database is initialized using seed material comprising (i) a philosophical cornerstone to guide ethical behavior according to the selected philosophy and (ii) a body of text representing fundamental world knowledge.
